(19) United States
(12) Patent Application Publication
(10) Pub. No.: US 2003/0138529 A1
(43) Pub. Date: Jul. 24, 2003

(54) Candy package

(76) Inventors: Richard M. Palmer, Reading, PA (US); Joanne Trois, Reinholds, PA (US); James Tucker, (US); Stephen Terroni, Sinking Spring, PA (US)

Correspondence Address: PAUL AND PAUL, 2900 TWO THOUSAND MARKET STREET, PHILADELPHIA, PA, 19103, US

(21) Appl. No.: 10/051,511

(22) Filed: Jan. 18, 2002

(51) Int. Cl. A23B 4/00

(52) U.S. Cl. 426/119

(57) ABSTRACT

A candy package is provided, having a container and an openable lid or closure, with the container being divided into a plurality of cells. A plurality of candies are provided in each cell, with the candies simulating the appearances of various forms of fishing tackle and the container and lid simulating the appearance of a fishing tackle box.

### BACKGROUND OF THE INVENTION

It is known in the art to provide candy in packages. It is likewise known to provide candy in compartments, in which various candies of the same general size are packaged in compartments of the candy package, and in which candies of other sizes are packaged in different compartments of the candy package.

### THE PRESENT INVENTION

The present invention is directed toward providing a novel package of candy, in which different sizes, shapes and formulations, including tastes, of candy are each located in their own compartments, and wherein the candies simulate the appearances of various forms of fishing tackle, and wherein the container in which the candies are packaged simulates a fishing tackle box. Thus, the present invention is directed toward presenting a package of candy having a plurality of cells, in which individual cells contain candy that simulates various forms of fishing tackle, such as worms, bait fish, lures, fishing weights, floats, etc., with a given cell containing similar fishing tackle, that may differ from the fishing tackle in another cell.

### SUMMARY OF INVENTION

The present invention is therefore directed to providing a candy package simulating a fishing tackle box, and containing candies that simulate various forms of fishing tackle.

It is a further object of this invention to accomplish the above object, wherein the package includes an openable cover, with the cover hingedly connected to a container base, and having a clasp means for holding the cover or lid closed on the container base.

Accordingly, it is an object of this invention to provide a novel candy package simulating a fishing tackle box with fishing tackle disposed therein.

It is a further object of this invention to accomplish the above object, wherein the fishing tackle box or container comprises a plurality of cells.

It is yet another object of this invention to accomplish the above object, wherein each cell contains like candies, each of which simulates fishing tackle.

Other objects and advantages of the present invention will be readily apparent upon a reading of the brief descriptions of the drawing figures the detailed descriptions of the preferred embodiments and the appended claims.

### BRIEF DESCRIPTIONS OF THE DRAWING FIGURES

FIG. 1 is a top plan view of the fishing tackle box or container of this invention, with the openable lid or cover thereon being shown broken away, for clarity of illustration of the candies in various cells of the fishing tackle box.

FIG. 2 is a lower end view of the fishing tackle box of FIG. 1, taken generally along the line of II-II of FIG. 1.

FIG. 3 is fragmentary transverse sectional view taken through a cell of the fishing tackle box of FIG. 1, generally along the line III-III of FIG. 1.

FIG. 4 is a transverse sectional view, taken through a cell of the fishing tackle box of FIG. 1, generally along the line IV-IV of FIG. 1, and wherein the hinge and closure are illustrated in section.

FIG. 5 is a transverse sectional view taken through one of the candies that simulates a lead weight in one of the cells of the fishing tackle box of this invention, generally along the line V-V of FIG. 1.

FIG. 6 is a sectional view taken through one of the simulated floats in one of the cells of the fishing tackle box of this invention, generally along the line VI-VI of FIG. 1.

### DETAILED DESCRIPTIONS OF THE PREFERRED EMBODIMENTS

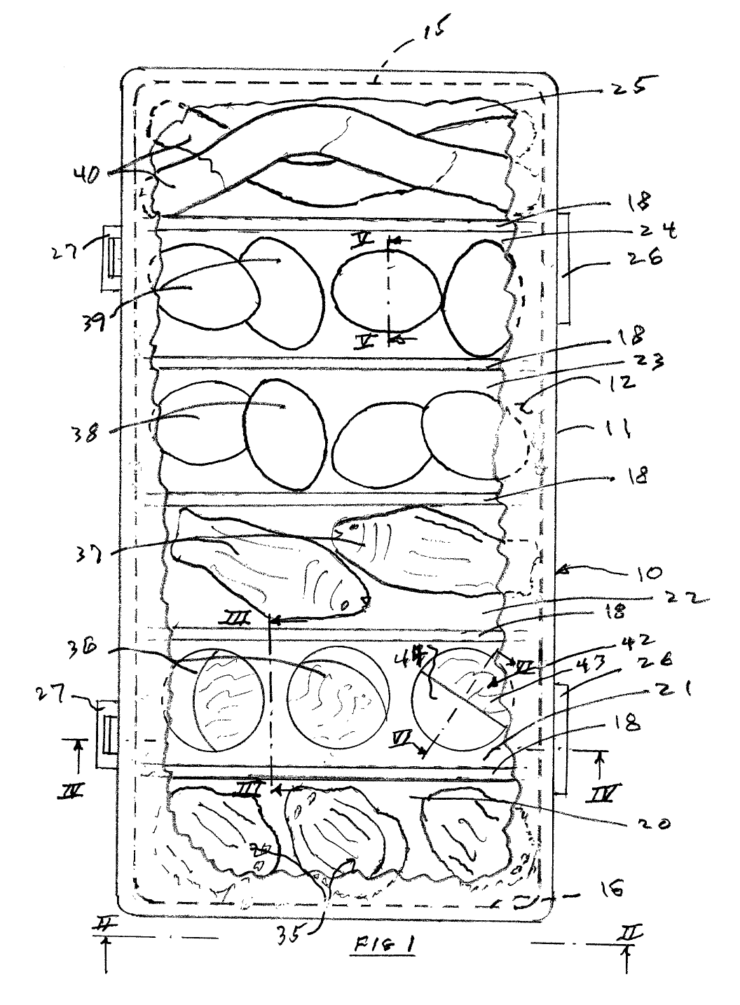

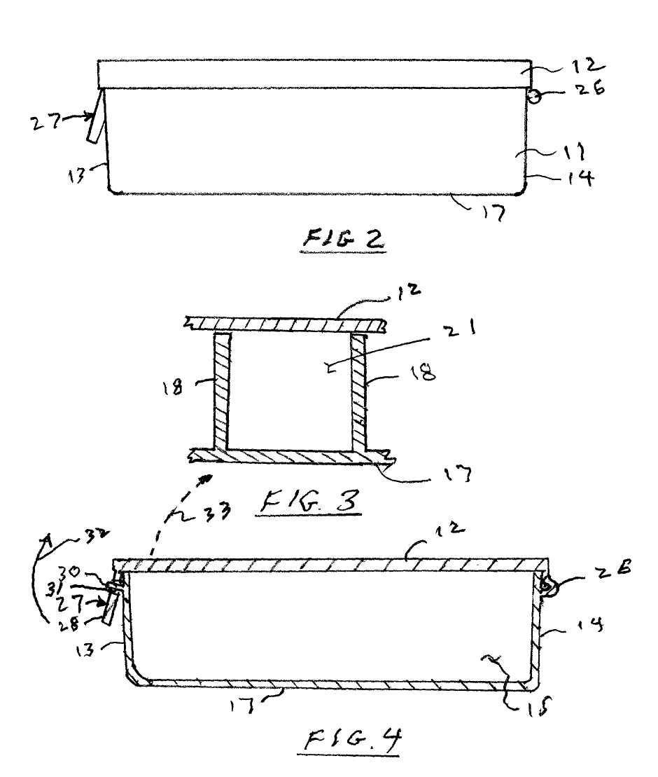

Referring now to the drawings in detail, reference is first made to FIG. 1, wherein the fishing tackle box is generally designated by the numeral 10, as comprising a container 11 and a lid or closure 12.

The container 11 is defined by front and rear side walls 13 and 14 respectively, and end walls 15 and 16, as shown in FIG. 1, each of which end walls are at right angles to the side walls 13 and 14. A bottom wall 17 connects the side walls and end walls. A plurality of separator panels 18 are provided extending between side walls 13 and 14, and dividing the container 11 into a plurality of cells 20, 21, 22, 23, 24, and 25.

The lid 12 is hingedly connected to the rear wall 14 by a pair of hinges 26 and is maintained in the openable closed position by means of clasps 27 at the front wall 13, which comprise flap members 28 that are carried by the lid 12 and are generally integral therewith, and which are pivotally moveable to engage over tongues 30 that, in turn, are integrally carried by front wall 13, extending outwardly as shown in FIG. 4, to be engaged within slots 31 of the clasps 27, when the clasps are in their closed position illustrated in FIG. 4.

In order to open the lid, the flaps 28 are engaged and moved upwardly, in a clockwise direction as indicated by the arrow 32 in FIG. 4, for the slots 31 to clear the extended tongues 30, such that the lid 12 can pivot in the direction of the dotted arrow 33 of FIG. 4, about the hinge 26.

Preferably the container 11 and lid 12 are of thermoplastic construction, and may be preferably molded into the general configurations as shown.

With reference now to FIG. 1, it will be seen that the candies 35, 36, 37, 38, 39, and 40 that are located in respective cells 20, 21, 22, 23, 24, and 25, each represent forms of simulated fishing tackle.

For example, the bait 35 located in cell 20 simulates lures in the shape of tiny frogs or like creatures. The candies 35 may, for example, be of chocolate, jell or gum composition, as may be any of the candies that simulate fishing tackle in accordance with the package of this invention.

The simulated fishing tackle in the form of simulated floats 36 in cell 21, and as shown more specifically in FIG. 6, comprise candies 41 with a wrapping 42 thereabout, such as in the form of aluminum foil or the like, of two different colors 43 and 44, representing, for example, red and white portions respectively of the wrapping 42, to give the visual appearance of a conventional float or bob.

With reference now to the simulated tackle 37 of cell 22, such may simulate bait fish, as shown, also of any particular candy formulation, such as gum-like candies, chocolate, jells, etc.

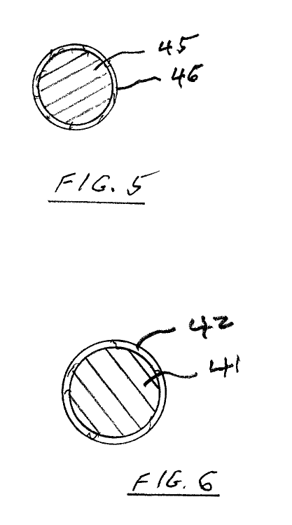

The candies 38 and 39 appearing in cells 23 and 24, and also shown in cross-section in FIG. 5, may comprise centers 45 of chocolate, jell, gum, or the like, with a wrapping 46, again, for example of aluminum foil wrapping or the like, such that the candies 38 simulate lead fishing weights, in that the wrapping 45 may be of a color to simulate lead fishing weights when applied about the candies 46.

The tackle 40 shown in cell 25 may be comprised of any suitable candy type as discussed above, or of other candy types, and is shown in the illustration of FIG. 1 to simulate worms.

It will thus be seen that the package of this invention presents a novel presentation of candies that simulate fishing tackle, and which are disposed in a container that, in turn, is constructed to simulate a fishing tackle box.

It will be understood that in the practice of this invention, various modifications may be made in selecting the type of candies that are disposed in the cells, in altering their color, appearance, sizes and shapes. Additionally, the number of cells present in the fishing tackle box may also be modified to present a greater or fewer number of cells and that the details of construction of the fishing tackle box may be varied all within the spirit and scope of the invention as defined in the appended claims.

What is claimed is:

1. A candy package comprising candy and a container, with the candy being disposed in the container; and
(a) the container comprising a bottom, two side walls and two end walls;
(b) with a plurality of separator panels disposed generally parallel to a least some of said walls and dividing the container into a plurality of open-topped cells;
(c) a lid for the container; the lid being moveable between
(i) a closed position in which it closes the open-topped cells to retain candy in a given cell from passing into another cell and
(ii) and open position in which the open-topped cells are accessible for removal of candy therefrom;
(d) openable closure means associated with the container and lid for maintaining the lid in the closed position until it is desired to open the lid;
(e) the container simulating the appearance of a fishing tackle box; and
(f) the candy in the cells simulating the appearance of fishing tackle.

2. The package of claim 1, wherein the candy in at least one cell comprises simulated bait.

3. The package of claim 2, wherein the candy in at least one cell comprises simulated worms.

4. The package of claim 2, wherein the candy in at least one cell comprises simulated bait fish.

5. The package of claim 1, wherein the candy in at least one cell comprises simulated lures.

6. The package of claim 1, wherein the candy in at least one cell comprises simulated fishing weights.

7. The package of claim 1, wherein the candy in at least one cell comprises simulated floats.

8. The package of any one of claims 2-7, wherein all the candy in a given cell corresponds to and is similar in appearance to, all other candy in that cell.

9. The package of claim 1, wherein hinge means are provided, hingedly carrying the lid on the container, and wherein the closure means comprises clasp means for securely clasping the lid closed on the container.

10. The package of claim 6, wherein each said candy in the cell having simulated fishing weights is provided with a lead-simulating wrapping.

11. The package of claim 7, wherein each said candy in the cell having simulated floats is provided with a multi-colored wrapping.

12. The package of claim 1, wherein the candy in at least one cell comprises simulated bait, wherein the candy in at least one cell comprises simulated worms, wherein the candy in at least one cell comprises simulated bait fish, wherein the candy in at least one cell comprises simulated lures, wherein the candy in at least one cell comprises simulated fishing weights, wherein the candy in at least one cell comprises simulated floats, wherein all the candy in a given cell corresponds to and is similar in appearance to, all other candy in that cell, wherein hinge means are provided, hingedly carrying the lid on the container, and wherein the closure means comprises clasp means for securely clasping the lid closed on the container, wherein each said candy in the cell having simulated fishing weights is provided with a lead-simulating wrapping and wherein each said candy in the cell having simulated floats is provided with a multi-colored wrapping.
